(19) United States
(12) Patent Application Publication
(10) Pub. No.: US 2009/0111488 A1
(43) Pub. Date: Apr. 30, 2009

(54) Method of Communicating Multimedia Messages Among Remote Terminals Using a Programming Agent

(76) Inventors: Jean-Marie Vau, Paris (FR); Thierry Lebihen, Paris (FR); Olivier M. Rigault, La Celle St Cloud (FR); Olivier A. Furon, Dinard (FR)

Correspondence Address: EASTMAN KODAK COMPANY;PATENT LEGAL STAFF, 343 STATE STREET, ROCHESTER, NY, 14650-2201, US

(21) Appl. No.: 10/585,891

(22) PCT Filed: Feb. 7, 2005
(86) PCT No.: PCT/EP2005/001206

§ 371 Date: Jul. 11, 2006

(30) Foreign Application Priority Data
Feb. 17, 2004 (FR) 0401549

(51) Int. Cl. H04W 4/00

(52) U.S. Cl. 455/466

(57) ABSTRACT

The invention is in the technological field of imaging. The invention relates more specifically to a colximunication method between at least two terminals (10A, 10B), and based on the sending from a first terminal (10A) to at least one second terminal (10B) of a multimedia message comprising a programming agent (36), consisting in automatically starting, using the programming agent, the establishment of a phone link between the first terminal (10A) and the at least one second terminal (10B). The programming agent also starts automatically, on the second terminal (10B), the formation of a multimedia message intended to be sent automatically to the first terminal (10A). The invention is preferably implemented in networks that require the use of mobile terminals.

### FIELD OF THE INVENTION

The invention is in the technological field of imaging. The invention relates to a method to supply a multimedia application on a terminal, using a programming agent. The invention also relates to an imaging system in which the programming agent manages the communication of digital data among terminals and service platforms that can inter-communicate. The invention is preferably implemented in networks that require the use of mobile terminals.

### BACKGROUND OF THE INVENTION

Many programmed applications (software) and online services existing in the prior art, and implemented especially in wireless communication networks, like for example mobile telephony networks, are adopted slowly, even reluctantly, by potential users, because of the differences and disparities of platforms and environments that these networks have. For example, various proprietary systems available and used in mobile telephony, like Brew, Linux, Microsoft, Java, Symbian, etc. can be mentioned. For example, Java MIDP is a software platform, known and commonly used in mobile telephony, but it has certain disadvantages as to access capability, for example to images or other digital data saved in a mobile (portable) terminal.

SMS (Short Message Service) type messages or MMS multimedia type messages (Multimedia Message Service) comprising digital data of images, text and sound are communication supports generally used with mobile terminals. Applications to compose MMSs are increasingly widespread. These applications can be used to compose, for example, postcards in an MMS structure, but they are not suitable for creating postcards in satisfactory conditions for the terminal user. One disadvantage is that the interfaces, in particular on mobile terminals, are more or less complex and lack ease-of-use, i.e. they are not easy to use by a non-specialist user. The actions to be carried out to create for example an electronic postcard with a specific application, in an MMS structure, require special characters to be placed, like for example “hash #”, to separate the text from the other elements of the postcard (address, etc.). Such methods, used to define the various elements (text, address, etc.) added in the postcard frame, lead to a high rate of postcard formatting errors. Consequently, the terminal user is dissatisfied, because the method does not reproduce what he/she is entitled to expect, and if the user sends the composed message (e.g. postcard completed with added text) to the other persons having for example mobile terminals, these addressees will also be dissatisfied. Therefore it seems necessary to provide applications to compose for example electronic postcards, which are easier to use, and produce better composition results.

By definition, mobile terminals are limited in memory capacity and display capacity. They are thus less capable of being easily maintained and updated with the latest versions of proposed applications (new software versions).

Furthermore, it is not desirable, because of the limited memory capacity, to load a large number of potentially useful applications onto the mobile terminal. In a conventional network environment of communication among mobile terminals or among mobile terminals and service providers' platforms, the communication modes generally used are of SMS, MMS, or WAP (Wireless Application Protocol) type. To transmit SMSs or MMSs, terminals generally communicate with one or more central servers of SMS-Centers or MMS-Centers type. In particular these servers enable the temporary saving of data, transmitted by a first terminal, before sending them to a second addressee terminal. The terminals can be fixed, such a PC (Personal Computer) or mobile, such a cellphone or camera phone. This communication mode, used for SMS (text) and MMS (text, image, sound) transmissions among terminals, has the disadvantage of latency. According to the traffic, that is the network's congestion, it often takes several seconds, even several dozen seconds, to transmit an SMS between two terminals, and several dozen seconds, even some minutes, to transmit an MMS between two terminals. In the case of WAP data transmission, downloading for example an Internet site onto a terminal or downloading any application (software) has the disadvantage that the connection can be cut during the download and, therefore, all the downloading procedure has to be repeated. The loading times incurred and the service quality are incompatible with the terminal user's expectations, and all the more so with a mobile terminal user's expectations; because the mobile terminal user generally requires communications immediacy.

The mobile terminals environment is thus subject not only to latency problems, but also to the constraints of response immediacy. That is, the possibility of sending data by communicating them instantly, i.e. in real time, is an important need. But the retransmission or the response from the terminal receiving these data must also be capable of being carried out immediately. The immediacy need, involving minimum latency in communications operated among terminals, is all the more necessary as the obtaining of immediate communications of SMS or MMS messages, for example between remote mobile terminals, i.e. far away from one another, can become crucial, if personal safety issues are involved. In this context, the information exchanged among terminals must be done practically immediately. Safety issues relate to the remote monitoring, for example using a portable terminal, of a person's health, or the safety of a very young child, with the latter themselves being provided with or near to a portable terminal. If the person is near to the portable terminal, he/she is for example capable of speaking, but may not be capable of getting hold of the terminal, because of a physical impossibility for example. In this case, a fast and effective information communication method is necessary.

Content search methods using a search agent are known in the prior art. For example, sending to a terminal, like a PC (Personal Computer) or a portable terminal, a request in the form of a search agent whose purpose is to find a file with a given name, having a given content, is known in the prior art. The search agent, after having found the requested content, sends the search result back to the requesting terminal. However, these search agents have limited application in the scope of multimedia applications.

Another disadvantage concerns the communication between one or more mobile terminals, for example a camera phone, and a platform for executing imaging work, like for example a photographic kiosk capable of producing prints. The difficulty is to be able to manage data communications with the kiosk, for the non-expert user of the mobile terminal, who wishes for example to customize a digital image presentation, by enhancing it with other data supplied by the kiosk. The image, captured for example with a camera phone, can be put into a particular format, representing for example a diary, or a postcard of the place where image was-captured. The user's objective is to produce, in a fast and friendly way, an end product comprising the image data and the diary or postcard data. Existing interfaces are often more or less complex, according to the capabilities of the terminal or kiosk. Therefore the production of a composed product (images and text, in a chosen frame format) is fairly lengthy and requires several interventions by the terminal user, for example using the terminal's keyboard. Therefore there is a need to improve the existing interfaces, to make them friendlier, by reducing the user's manual interactions to the minimum.

The interfaces problem is emphasized if several terminal users, for example mobile terminal users, wish to produce a common composed product, formed by specific digital data coming from each terminal, in order to edit the common composed product on a platform for executing imagery work, like a photographic kiosk.

An additional drawback is the complexity, for the platform executing the imaging work, of interacting simultaneously with many terminals, except by using priority rules that generate waiting times incompatible with the immediacy expected by the user, positioned for example in front of a photographic kiosk, with his/her mobile terminal, to unload his/her data. The wait is accentuated by the use of the kiosk by other users lining up in front of the kiosk.

Thus it is desirable to resolve all the drawbacks described above, and met with by the terminal users, especially mobile ones, used in various network environments, so as to reduce the format or formatting errors of composed multimedia messages, and to obtain immediacy as to the communications operated between terminals and between terminals and platforms of the photographic kiosk type.

### SUMMARY OF THE INVENTION

The purpose of the present invention is to remedy the above-mentioned problems of the prior art. The object of the present invention is to supply a terminal user, for example of a mobile terminal (portable), with a friendly interface enabling the user to easily create multimedia messages free of formatting errors, independently of the network environment in which the terminal is placed during the message formatting.

One object of the invention, as regards the prior art, is to share central intelligence, by distributing this intelligence to the terminal, by means of a programming agent that is sent to the terminal. The programming agent is an encoded program linked to a multimedia message. Data making up the multimedia message come from several sources: for example the terminal and a photographic kiosk or an online service that can communicate with the terminal.

The present invention relates more specifically to a method to supply a multimedia application on a terminal, with a programming agent, comprising the following steps.
a) automatically send from an applications server to the terminal a digital data support containing the programming agent, based on the digital data of a first message initially sent from the terminal to said applications server;
b) automatically extract, from the terminal, the programming agent from the data media;
c) automatically save the programming agent in the terminal.

The digital data medium according to the invention is a multimedia message of MMS type capable of containing image, text, sound, and programming code data. The programming agent can be displayed on the terminal's screen. The programming agent is an encoded program placed in the data medium. When activated, the programming agent executes an application program to automatically format, for example, an electronic postcard. The code data of the programming agent are automatically destroyed when the programming agent is deactivated.

The invention method also enables a request for the execution of imaging work to be sent from the terminal to an execution platform capable of communicating with the terminal.

The invention method also enables a digital data medium containing a programming agent to be sent from a terminal towards at least one other terminal.

An imaging system for supplying a multimedia application on a terminal is an object of the invention. The imaging system comprises at least one terminal, at least one applications server and at least one platform for executing imaging works capable of inter-communicating, characterized in that each at least one terminal is capable of activating at least one programming agent to operate an application programmed according to the method described above.

It is also an object of the invention to provide a method for automatically communicating digital data between many terminals capable of inter-communicating and with an applications server, characterized in that programming agents specific to an application are sent from the applications server to each terminal so that the programming agents interact when they are activated on each terminal, to produce a composed multimedia message with a combination of digital data coming from each terminal. The method enables request priorities to be determined for imaging work transmitted from each of the terminals to the execution platform.

It is also an object of the invention to provide a communication method between at least two terminals, and based on the sending from a first terminal to at least one second terminal of a multimedia message comprising a programming agent, consisting in automatically starting, using the programming agent, the establishment of a phone link between the first terminal and the at least one second terminal. The programming agent also starts automatically, on the second terminal, the forming of a multimedia message intended to be sent automatically to the first terminal.

Other characteristics and advantages of the invention will appear on reading the following description, with reference to the various figures.

### BRIEF DESCRIPTION OF THE DRAWINGS

FIG. 1 represents an example of the digital network architecture of the prior art, to create for example a postcard.

FIG. 2 represents the architectures of MMS data media, respectively according to the prior art, and according to the invention.

FIG. 3 represents a diagram of an embodiment according to the invention, for example a postcard, in an imaging works laboratory environment.

FIG. 4 represents a diagram of an embodiment according to the invention, for example a postcard, in a photographic kiosk environment.

FIG. 5 represents a communication of digital data according to the invention, in a context of many terminals.

FIG. 6 represents a communication of digital data according to the invention, in a context of remote monitoring between two terminals.

### DETAILED DESCRIPTION OF THE INVENTION

The following description is a detailed description of the main embodiments of the invention, with reference to the drawings, in which the same numerical references identify the same elements in each of the different figures.

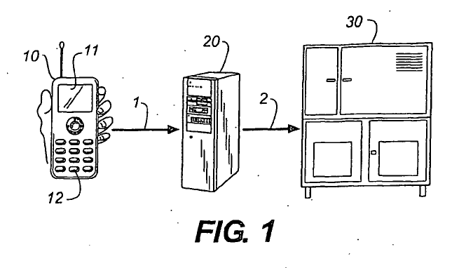

FIG. 1 represents diagrammatically an example of communication in a digital network. A terminal 10, for example a cellphone equipped with a keyboard 12 and a display screen 11, sends by link 1, for example GPRS type (General Packet Radio System), multimedia message data to a central server 20. The terminal 10 can also be a camera phone, a wireless camera, or a PDA (Personal Display Assistant). The server 20 is typically an SMS-Center or an MMS-Center. The server 20 enables data sent by the terminal 10 to be saved, and enables a service to be supplied, for example a multimedia message composition application, to compose for example an electronic postcard: The electronic postcard can contain image or text digital data to which sound data can be linked. The server 20 sends secondly, by a link 2, for example GPRS type, data to a platform for executing photographic work, like for example a photographic laboratory 30, which will execute for example a print of the postcard thus composed. Apart from the problems of communication latency, the creation of the postcard involves, because of the more or less complex user interfaces, several manual interventions that are not always easy to perform, based on the terminal 10. The consequence is that the results of formatting the postcard, i.e. the data layout, have a significant error rate.

FIG. 2 represents a digital data medium architecture 21, of MMS type, according to the prior art. The MMS architecture 21 includes support or saving means of image 22, text 23, sound (audio) 24 data, or even video data 25. These text, still or moving image (video), or sound data constitute the contents of a multimedia message.

FIG. 2 also represents an architecture 31 of MMS digital data medium, according to the invention. The MMS architecture 31 also includes support or saving means of image 32, text 33, sound (audio) 34 data, or even video data 35. The MMS architecture 31, according to the invention, includes a programming agent 36. The programming agent 36 is comprised of encoded digital data that constitute an application program. The programming agent 36 is included in the MMS architecture 31. The MMS architecture 31 including the programming agent 36, is also called MMS-agent. The MMS-agent 31 is a vector for transporting the encoded data of the programming agent 36. The MMS-agent 31 uses the known medium of the MMS multimedia message. The MMS-agent 31 can thus be transmitted easily from a server, to an identified mobile terminal. The programming agent 36 is for example written in a Java MIDP language, or another language used with mobile terminals. According to the programming script, the agent corresponds to specific applications containing encoded instructions to automatically execute, for example a postcard composition, the organization of image data formatting according to the display capacity of a terminal, the management of the communication of the data with other programming agents, or any other imaging application capable of being useful for terminal use. The programming agent has a fundamental interest: it is a single-use application. The application is single-use, because it is deleted following its use. This is particularly advantageous when mobile terminals are used having reduced memory capacities.

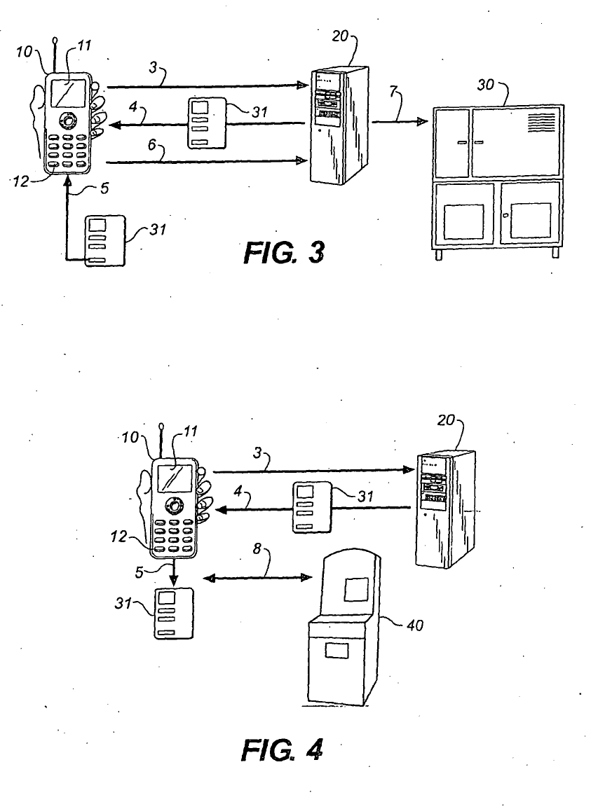

FIG. 3 corresponds to a first embodiment of the invention, which represents a diagram to produce, for example, a postcard by using an MMS-agent 31. The terminal 10 sends, by a link 3, a first message to the applications server 20. The terminal 10 is for example a cellphone, a camera phone, or a PDA. The link 3 is preferably a wireless link, like for example a signaling channel adapted to the GSM network (Global System for Mobile), or WAP or GPRS type links, to transmit e-mails, SMS or MMS. The first message comprises digital data. The digital data are for example a number with several digits of a known applications service, and optionally a short text targeting the sought application: for example “postcard”. The applications server 20 contacted by SMS, then automatically sends an MMS-agent 31, by a link 4, to the terminal 10. The link 4 is preferably a wireless link, like GPRS. The MMS--agent includes the programming agent 36 that corresponds to the requested application. In a preferred embodiment of the invention, the user is notified of the arrival of the MMS-agent on his/her terminal, by an alphanumeric display identifying the programming agent, or simply by displaying the programming agent on the screen 11, as an icon. At this stage, following a link 5, the programming agent 36 is automatically extracted from the MMS data medium, and is saved in the terminal 10. The extraction is performed by a special application, saved in the terminal 10. This special application occupies little memory space, and is called an “agent nest framework”. The special application, “agent nest framework”, is advantageously used to reduce blocking of the memory with the programming agent code. It also enables the programming agent to be recognized and activated. The user of the terminal 10 activates the programming agent 36, by clicking on the displayed icon of the programming agent. In a variant of the embodiment, the user of the terminal 10 activates the programming agent by opening the MMS data medium containing the agent (the MMS-agent), which automatically starts the production of the application programmed by the programming agent 36. The programming agent 36 automatically displays the interface elements on the screen 11 of the terminal 10. The interface elements enable, for example, the postcard to be displayed on the screen 11, and additional image, text, mailing address, etc. data to be added in the proposed postcard format, to customize the postcard. The interface elements are advantageously adapted to a platform for executing imaging work, or an online service. The programming agent is capable of automatically identifying a platform for executing imaging work, to send an imaging work execution request from the terminal to the-execution platform. The additional data are advantageously image data linked to the postcard context: for example an image of the Eiffel Tower in Paris (representing a place), or an Elton John photo (representing an event). If the programming agent 36 needs to connect to a personal zone, and thus secure, of online service, through WAP (e.g. access to a private zone of an online album, to use a personal image to compose the postcard), the programming agent 36 has the advantage of automating the connection (e.g. by transmitting an access code and password) thus making secure access very simple. This is linked to the fact that the programming agent 36 was sent unambiguously to the terminal 10, which is perfectly identified by the wireless network. The programming agent 36 then automatically formats the data added to the postcard, and the group or packet of formatted data is sent, by a link 6, to the server 20. The link 6 is preferably a wireless link, such as GPRS. The programming agent has the advantage of automatically performing the composition and formatting of the postcard; which avoids the formatting errors due to manual interactions carried out by the user. In a preferred variant of this embodiment of the invention, additional data concerning, for example, the identification of a processing laboratory 30, the type of work to be executed, the pricing of the products to be executed (e.g. as a discount or promotion), or the payment (account number to be debited) are attached to the data packet transmitted to the server 20. Then, the data packet is sent, by a link 7, to the laboratory 30. The link 7 is preferably a wireless link, such as GPRS. The laboratory 30 is a platform or a center for executing imaging work. The laboratory 30 can, for example, print a paper version of the postcard, and mail it to the address given on the postcard.

With the application finished, a deactivation destroys the code data of the programming agent. The programming agent is deactivated, either automatically when the data packet is sent to the server 20 by the link 6, or by the user, from the terminal 10. This is another advantage of the invention that avoids blocking the memory space of the terminal 10 with the encoded data of the programming agent's program.

FIG. 4 corresponds to a second embodiment of the invention, in an environment for example of a photographic kiosk. A first message is sent, by a link 3, from the terminal 10 to the-applications server 20. The first message is an SMS, an MMS, or an email. The first message includes data to identify the kiosk 40: e.g. a number or geolocalization coordinates supplied by an LBS geolocalization service (Location Based Services). The server 20 automatically sends, by the link 4, an MMS-agent 31 to the terminal 10. The MMS-agent 31 contains and carries the programming agent 36. The application, enabling for example a postcard or a year calendar to be created, is automatically implemented by the programming agent, as in the first embodiment described above.

However, in this second embodiment, the programming agent automatically establishes, according to a link 8, a connection to communicate digital data, from the terminal 10 to the kiosk 40, when the terminal 10 is located near the kiosk 40. The link 8 is preferably Bluetooth, IrDA, or WiFi type. The programming agent automatically establishes the communication between the terminal 10 and the kiosk 40, without any manual interaction by the terminal user. The programming agent also performs an automatic display of the user interface on the terminal 10. The interface is compatible with the kiosk 40, so that the user of the terminal 10, independently of the use of the kiosk by another user, can prepare an imaging work order from the terminal 10. An order that he/she could normally only prepare at the kiosk, after having unloaded his/her data, for example an image, from the terminal to the kiosk, and having waited, if necessary, for another user interacting with the kiosk to free the place at the kiosk's order panel. The programming agent, imported onto the terminal 10, has the advantage of sending an order command to the kiosk without waiting for the kiosk to be freed by the other user. Another advantage is that the user of the terminal 10 can for example get into a customer line in front of the kiosk, without going to the end of the line. The order capable of being placed from the portable terminal, is executed by the kiosk just after the work order of the other user using the kiosk.

A third embodiment of the invention, not represented by a figure, relates to a multi-user context, in a photographic kiosk environment similar to that represented on FIG. 4. Several users of mobile terminals 10, such as cellphones, camera phones, or PDAs, are located near a platform for executing imaging work, like for example the kiosk 40, and wish to create a common composed product formed by digital data coming from various terminals. The common composed product is typically a multimedia message. The multimedia message can comprise image, text and sound data. The final common composed product required is for example a print comprised of images and texts of the multimedia message. The images and parts of text come from each of the various terminals. The invention method, according to this third embodiment, is characterized in that the programming agents 36 are sent, by using an MMS-agent 31, from the applications server 20 to each of the terminals placed near the kiosk 40. The programming agents interact, when they are activated on each terminal, to produce the multimedia message comprised of a combination of digital data coming from each terminal. The digital data corning from each terminal are image, text, or sound data. The programing agent enables a user interface to be produced on each terminal, to display for example the multimedia message. The programming agent is capable of identifying a platform for executing imaging work, like the photographic kiosk 40, to send an imaging work request from the terminal to the execution platform. The digital data sent from the terminal to the platform for executing imaging work are text or image data of the multimedia message. The communication link of the digital data between the terminals and the kiosk 40 is a wireless link, such as Bluetooth or WiFi. The connection between the terminal and the kiosk is advantageously made secure. This means that the digital data transferred between the terminal and the kiosk cannot be intercepted or polluted.

In this third embodiment, the programming agents specific to each of the terminals interact and interact with the platform for executing the imaging work 40 in order to determine the priorities of the work execution requests, on the basis of the multimedia message data prepared in common among the terminals. The requests are transmitted, from each of the terminals, to the platform for executing prints 40. The programming agent 36 produces an interface to automatically display, on each terminal, information associated with the execution of requests specific to each terminal; these requests are for example prints of the multimedia message prepared in common. Time information (e.g. hour, minute of the print) can be displayed automatically on each terminal having sent, for example a printing request of the multimedia message, to the kiosk 40. Like in the previous embodiments, the code data of the programming agent are automatically destroyed when the programming agent is deactivated. This deactivation takes place automatically at the end of the application's use, or the deactivation is performed manually, for example using the keyboard 12 of the terminal 10.

An additional advantage of the MMS architecture is that existing payment methods adapted to mobile terminals, for example SMS/MMS Premium type, enable the invoicing of single-use applications, that is the MMS-agents, to be produced easily. According to FIGS. 3 and 4, the invoicing is, for example, divided into three steps. The initiation of a first payment is performed when sending the first message, by link 3. Then, the initiation of a second payment is performed to receive the MMS-agent, by link 4. And finally, the initiation of a third payment is performed, by links 6 and 7, or by link 8. This third payment corresponds, from the composed multimedia message (e.g. a postcard), to work requests either to the laboratory 30, or to the kiosk 40.

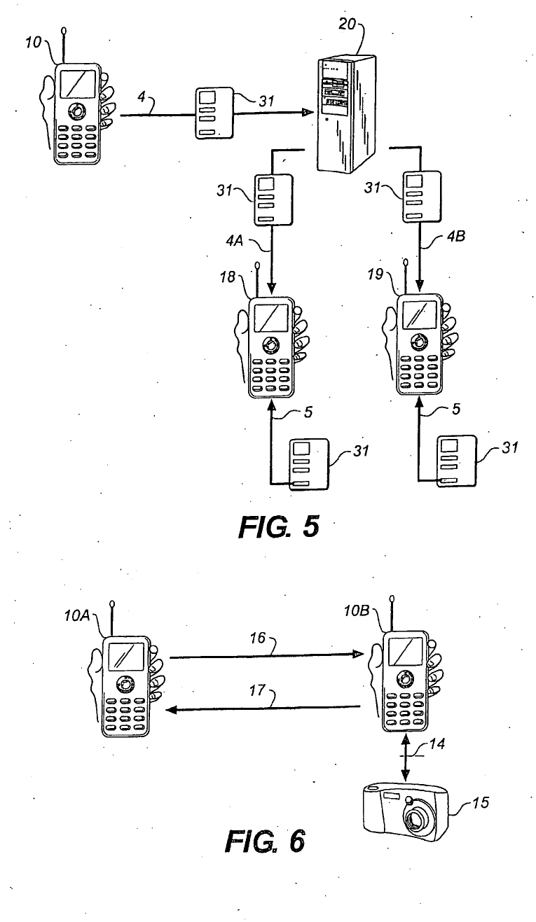

FIG. 5 represents an example of a variant of the first embodiment. It is no longer a matter of communicating MMS-agents between a server and a terminal, but of communicating MMS-agents among several terminals. FIG. 5 represents an example where a digital data medium containing a programming agent is sent to at least one other terminal. This embodiment corresponds to sending an MMS-agent 31 from a first terminal 10 to at least a second terminal 18, 19. According to FIG. 5, when the terminal 10 receives for example the digital data medium 31 containing the programming agent, that is an MMS-agent, the MMS-agent 31 is sent by wireless links 4, 4A, 4B, for example GPRS type links, to terminals 18 and 19. The programming agent is then extracted, by link 5, from the digital data medium 31, and saved respectively in terminals 18 and 19.

FIG. 6 represents a communication of digital data according to the invention, between two terminals, in a context of remote monitoring between these two terminals. The particular context of the monitoring application requires any system latency to be suppressed, to force and obtain digital data communications in real time, i.e. practically instantaneously. Examples of applications enabling remote monitoring to be performed, between two terminals, exist in the prior art. One example of known visual remote monitoring is the triggering, from a first terminal sending an SMS to a second terminal located at a distance, of the capture of a still or moving (video) image by the second terminal. Generally, these applications operate with PC type terminals, and are saved in the terminals, and thus use memory space, whereas they are only used periodically for planned or occasional control. Periodic control is typically the monitoring of an ill or disabled person or a newborn child, who require remote monitoring. It is preferable that the person who performs the monitoring, and who is liable to move about is no longer dependent, in order to obtain information immediately, only on a fixed PC type terminal, which they have to go to. If the person who performs the monitoring preferably uses a mobile terminal 10A, it is desirable that the terminal does not have its memory space blocked with an application that is only used periodically. On the other hand, the person performing the remote monitoring, has to carry it out quickly, and thus must have the most automated application possible, which avoids more or less lengthy or complex interactions with the terminal 10A. The monitored person must themself have means for answering, for example just by using the voice, without having to get hold of the terminal 10B near to them. There is thus a need to avoid users' manual interactions with their respective terminals, while not blocking the terminals' memories with applications that are only used periodically. The invention method answers this need by implementing the MMS-agent. At the time of sending, from the first terminal 10A (monitoring), by a link 16, to at least a second terminal 10B (monitored), a multimedia message including a programming agent, i.e. an MMS-agent, the programming agent is scripted to automatically start a phone link between the first terminal 10A and the second terminal 10B. The link 16 is preferably a wireless link, such as OSM or GPRS. The phone link consists in the activation, using the programming agent, of the voice channel and the loudspeaker of the second terminal 10B. In a preferred embodiment of the invention, the programming agent can start also automatically, an audible alarm on the second terminal, or a display of a video sequence, for example comprised of colored images for attracting the attention of the monitored person, located near the second terminal 10B. The programming agent can trigger, on the second terminal 10B, the formation of a multimedia message intended to be sent automatically, by link 17, to the first terminal 10A. The link 17 is preferably a wireless link, such as GSM or GPRS. This multimedia message is an MMS-agent that includes image, text, and sound digital data, and the encoded data of the programming agent. The digital data are contextual data specific to the monitored person, located near the second terminal 10B. The sound data characterize for example words or noise made by the monitored person, located near the terminal 10B. The image data characterize for example a video sequence filming the monitored person. This video can be produced automatically by a third terminal 15 capable of communicating, by a wireless link 14, with the second terminal 10B. The third terminal 15 is for example a camera. The link 14 is for example a Bluetooth, IrDA, or WiFi link. The contextual data, here the video, are collected automatically by the link 14 to be automatically included in the MMS-agent returned to the terminal 10A. Another embodiment not represented advantageously integrates the camera 15 into the terminal 10. The contextual data of the multimedia message can be displayed on the screen of the terminal 10A, in particular video data that are useful to the monitoring person, if the monitored person cannot express themself by voice. The code data of the programming agent are automatically destroyed when the programming agent is deactivated, at the end of the monitoring sequence.

1. A communication method between at least two terminals (10A, 10B), and based on the sending from a first terminal (10A) to at least one second terminal (10B) of a multimedia message comprising a programming agent (36), consisting in automatically starting, using the programming agent, the establishment of a phone link between the first terminal (10A) and the at least one second terminal (10B).

2. The communication method according to claim 1, characterized in that the phone link consists in the activation, using the programming agent, of the voice channel and the loudspeaker of the second terminal.

3. The communication method according to claim 1, characterized in that the phone link between the first and second terminal is a wireless link, such as GSM, or GPRS.

4. The communication method according to claim 1, characterized in that the programming agent also automatically starts an audible alarm on the second terminal (10B).

5. The communication method according to claim 1, characterized in that the programming agent also automatically starts the display of a video sequence on the second terminal (10B).

6. The communication method according claim 1, characterized in that the programming agent also automatically starts, on the second terminal (10B), the forming of a multimedia message comprised of digital data of image, text, sound and encoded data of the programming agent; the multimedia message being intended to be sent automatically to the first terminal (10A).

7. The communication method according to claim 6, characterized in that the multimedia message sent automatically to the first terminal (10A) comprises digital data, for example of image, text, or sound, and encoded data specific to the programming agent.

8. The communication method according to claim 7, characterized in that the digital data, for example of image, text, or sound are contextual data specific to user of the second terminal (10B).

9. The communication method according to claim 8, characterized in that the contextual data are collected on a third terminal (15) capable of communicating with the second terminal (10B) by a link (14), such as Bluetooth or Wifi.

10. The communication method according to claim 9, characterized in that the third terminal is a camera (15) capable of recording a video clip.

11. The communication method according to claim 6, characterized in that the multimedia message sent from the second terminal (10B) to the first terminal (10A) is automatically displayed on the first terminal (10A).

12. The method according to claim 7, characterized in that the code data of the programming agent are automatically destroyed when the programming agent is deactivated.
